(19) United States
(12) Patent Application Publication
(10) Pub. No.: US 2008/0161959 A1
(43) Pub. Date: Jul. 3, 2008

(54) Method to measure tool wear from process model parameters

(76) Inventors: Robert B. Jerard, Durham, NH (US); Donald Esterling, Carrboro, NC (US); Barry K. Fussell, Durham, NH (US); Min Xu, Charlotte, NC (US); Chad Schuyler, Georgetown, MA (US)

Correspondence Address: DEVINE, MILLIMET & BRANCH, P.A., 111 AMHERST STREET, BOX 719, MANCHESTER, NH, 03105, US

(21) Appl. No.: 11/998,884

(22) Filed: Dec. 3, 2007

Related U.S. Application Data
(60) Provisional application No. 60/872,151, filed on Dec. 1, 2006.

(51) Int. Cl. G06F 17/00

(52) U.S. Cl. 700/110

(57) ABSTRACT

A system and method for monitoring tool wear in CNC machining operations by monitoring spindle power and extracting instantaneous cutting geometry. The method is based on a physics-based two parameter process model and measuring at two different cutting conditions. The process model parameters are measured with easily accessible spindle power. In contrast to spindle power alone which is influenced by many factors, most especially by variable cutting conditions and by the tool condition, the process model parameters are independent of the geometrically variable cutting conditions and provide a simple and direct measure of tool wear. The two process model parameters change differently depending on the mechanism of the tool wear, specifically flank wear versus cutting edge degradation. This provides a diagnostic for tool wear.

### CROSS REFERENCE TO RELATED APPLICATIONS

The present application claims the benefit of Provisional Patent Application Ser. No. 60/872,151 filed Dec. 1, 2006, which is incorporated herein by reference.

### GOVERNMENT LICENSE RIGHTS

The U.S. Government has a paid-up license in this invention and the right in limited circumstances to require the patent owner to license others on reasonable terms as provided for by the terms of contract number, DMII-0322869 awarded by the National Science Foundation.

### TECHNICAL FIELD

The present invention relates to a mechanism to measure tool wear on a machine tool such as on a computer numerical control (“CNC”) metal removal machine.

### BACKGROUND OF THE INVENTION

There are a variety of tool wear mechanisms. These are commonly described as flank wear (a gradual loss of the rubbing face of the tool), notch wear (relatively sharp indentations in the cutting edge), crater wear (pits or holes forming on the cutting face of the tool), cracking, chipping and fracture of the cutting edge, and built-up edge formation (adhesion of the material being cut to the chip face of the tool). Each of these wear mechanisms affects the tool geometry near or at the cutting region of the tool. Three important concerns resulting from tool wear are a loss of surface quality (e.g. scoring), a loss of surface accuracy (due to a change in the nominal tool geometry and position of the cutting edge), and tool forces in excess of nominal sharp tool values which, for example, can cause the tool or tooth to break. Tool wear is monitored in CNC machining operations so a worn tool can be replaced before there is excessive damage to the part and/or the tool.

One conventional way to monitor tool wear is to monitor it directly by examining the tool or tooth edge under a microscope and observing defects. This requires the tool to be removed from production and so is most often used as a post-failure diagnostic tool. On-line and indirect tool condition monitoring has been investigated by a number of techniques, including optical methods, electrical resistance measurements, motor power consumption, force measurements, vibration, dimensional deviation, surface roughness, cutting temperature, and acoustic emission methods. Many of these methods are not practical in industrial applications since the sensors are complex and/or expensive.

One of the most commonly used methods to monitor tool condition is via spindle power. Spindle power can be measured with a relatively inexpensive sensor or obtained from the CNC control without an independent sensor if the CNC control is “open architecture” and permits such queries. Spindle power correlates with tool forces (more accurately, the tangential component of the tool forces), since, as the tool wears, the tool forces often increase and spindle power may provide an indirect measure of tool wear.

Unfortunately, there are deficiencies in conventional methods of determining tool wear. The systems and methods either require that the tool be taken off the production line, use complex and/or expensive methods to monitor tool wear, or do not accurately reflect tool wear.

### SUMMARY OF THE INVENTION

It has been recognized that there are a number of deficiencies in the current industrial practice of monitoring tool wear via spindle power. These include that the spindle power profile is different for different parts. So the learning process must be repeated for each new part geometry. In addition, the selection of a suitable offset for the spindle power alarm is problematic. There are no well established guidelines to determine when the tool wear is excessive. One solution is to cut with both a sharp and a dull tool to determine the spindle power process limits. But often several different tools are used to complete the machining of a particular part making the dual (sharp vs. dull tool) spindle power recording process overly cumbersome.

In addition, with particularly hard part materials, the tool wears very quickly and substantial wear can occur even over the first pass (“sharp tool” pass) for the part. Learning is not an option for this situation. Furthermore, small batch, such as custom manufacturing is becoming commonplace, even down to batch sizes of one. The current industrial tool condition monitoring systems are only practical for large production batch sizes which may amortize the initial time and expense of the recorded tool cuts.

The instant invention is a system and method for monitoring tool wear in CNC machining operations by monitoring spindle power and extracting instantaneous cutting geometry. The method is based on a physics-based two parameter process model and measuring at least two different cutting conditions. The process model parameters are measured with easily accessible spindle power. In contrast to spindle power alone which is influenced by many factors, most especially by variable cutting conditions and by the tool condition, the process model parameters are independent of the geometrically variable cutting conditions and thus provide a simple and direct measure of tool wear. The two process model parameters change differently depending on the mechanism of the tool wear, specifically flank wear versus cutting edge degradation. This provides a diagnostic for tool wear.

One embodiment is a method of measuring tool wear including monitoring the spindle power of a machine. At least two pieces of cutting geometry data are determined related to a work piece. At least two different cutting operations are performed on the work piece. Two process model parameters are calculated. The spindle power and the determining at least two pieces of cutting geometry data continue to be monitored and the variation of the process model parameters over tool use in the machining operation whereby the change in the process model parameters over tool use is a measure of tool wear.

In an embodiment, the at least two pieces of cutting geometry data include the material removal rate (MRR) and the contact area rate (CA).

In an embodiment, the material removal rate and the contact area rate is determined by cutting geometry data. In an embodiment, the at least two process model parameters include the tangent cutting coefficient (Ktc) and the tangent edge coefficient (Kte).

In an embodiment, the at least two process model parameters are determined using the equation P=Ktc*MRR+Kte*CA.

In an embodiment, a system for monitoring tool wear includes a machine having a spindle for receiving a tool for cutting a work piece and a mechanism for controlling the motion of the tool relative to the work piece. The system has a mechanism for determining the power of the spindle and a mechanism for determining at least two pieces of cutting geometry data related to the cutting of the work piece. A mechanism calculates at least two process model parameters based on the spindle power and the cutting geometry data. A mechanism outputs the process model parameters.

In an embodiment, the mechanism for outputting the process model parameter is a graphic display.

A method for monitoring tool wear in CNC machining operations includes using a physics-based two parameter process model and using spindle power and cutting geometry data to determine the process model parameters. The variation of the process model parameters is monitored over tool use in the machining operation whereby the change in the process model parameters over tool use is a measure of tool wear.

In an embodiment, the changes in the two process model parameters relative to each other is a diagnostic of the dominant tool wear mechanism.

In an embodiment, the spindle power may be measured directly or may be obtained from a suitable open architecture CNC control.

In an embodiment, the geometry of the cutting process may be determined with a suitable geometric modeling system working in concert with the spindle power measurements.

### BRIEF DESCRIPTION OF THE DRAWINGS

The foregoing and other objects, features, and advantages of the invention will be apparent from the following description of particular embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a perspective view of a metal removal machine with portions broken away;

FIG. 2 is a perspective view of an enlarged portion of a tool interacting with a work piece;

FIG. 3 is a schematic illustration of the cutting process showing the work piece and tools;

FIG. 4 is a graph of an example of spindle power versus time for various cutting conditions;

FIG. 5A is an isometric view of the tool;

FIG. 5B is a top view of a schematic illustration of a cutting process showing the work piece and tools;

FIG. 6 is a schematic of the method according to the invention; and

FIG. 7 is a sample graph of the variation in process variables (Ktc and Kte) over time.

### DETAILED DESCRIPTION OF PREFERRED EMBODIMENTS

The present invention uses process model parameters in place of spindle power to monitor the state of tool wear. The use of process model parameters removes the dependence of the wear criterion on part geometry and also provides a useful mechanism to distinguish between different tool wear mechanisms. Slowly varying tool wear mechanisms, such as flank wear, can be monitored in a progressive fashion with one class of process model parameters while another class of process model parameters can provide a precursor alert when more precipitous wear mechanisms (e.g. notch or crate wear) dominate.

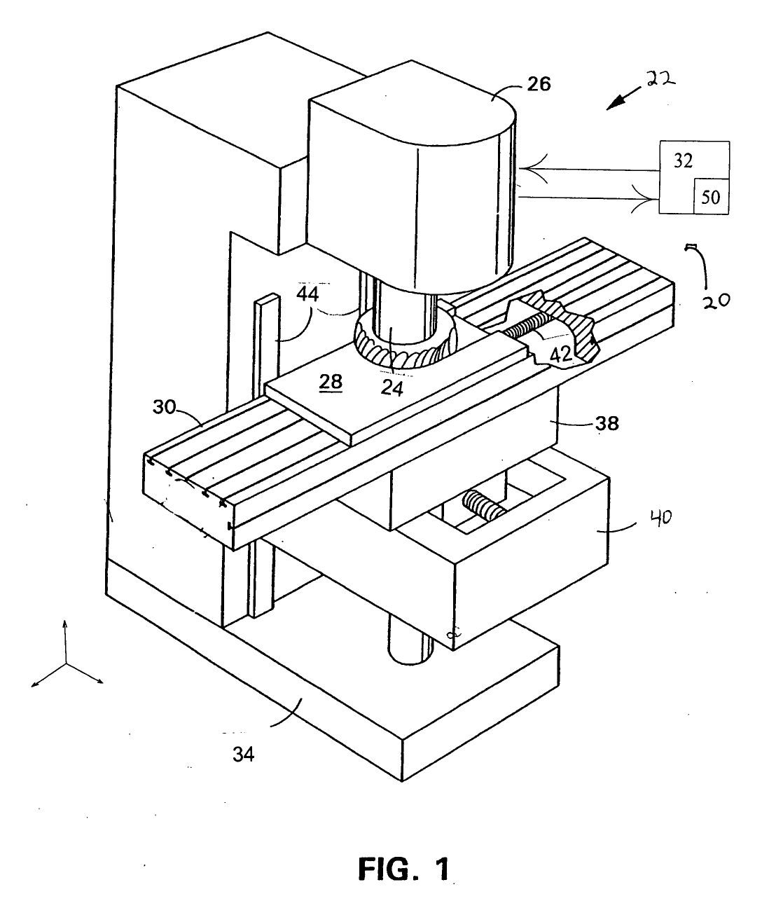

Referring to FIG. 1, a perspective view of a tool wear system 20 with a typical three axis milling (metal removal) machine 22 is shown. The tool wear system 20 has a machine tool such as the milling machine 22 with a tool 24. The tool 24 is held by a machine head 26 of the milling machine 22. The tool 24 operates on a work piece 28. The work piece 28 is held by clamps or other methods secured to a work table 30. Milling is a common example of metal removal operations performed by CNC machining.

In addition, the tool wear system 20 and the metal removal machine 22 have a computer control 32. The computer control in conventional systems directs the operation of the metal removal machine 22 including the movement of the tool 24 and the work table 30. In the metal removal machine 22 shown, the computer 32 controls the movement of the work table 30 by moving the work table in three directions relative to the base 34. The machine head 26 which receives the cutter or other tool 24 is rigidly connected to a base 34 such that the tool moves only in a vertical direction relative to the base 34. In order to allow the work table 30 to move relative to the base 34, a series of intermediate units are located between the work table 30 and the base 34, wherein each unit allows motion in one direction relative to its adjacent unit.

The units in the embodiment shown are the work table 30, the saddle 38 or a secondary base, and a knee 40. The knee 40 is adjustable in the vertical direction relative to the base 34. The computer 32 drives the motion through some mechanical devices such as a series of threaded screws 42.

The computer 32, also referred to as a controller, has a software package 50 that accepts programmed instructions to drive the tool 24 and the work table 30. The software package 50 receives input from the operator including the ultimate shape of the part to be machined, the type of material to be machined, and the tools 24 that can be used in the machining.

While FIG. 1 shows a single tool and a device in which the work table 30 moves, it is recognized and common to have other types of metal removal machines such saws, lathes, mills having multiple tools and spindles, mills with the work piece 28 clamped to a specific location and allowing the tool 24 to move in multiple directions/axis relative to the work piece and allowing the tool—work piece orientation to vary in more than along three Cartesian directions, such as including rotational degrees of freedom.

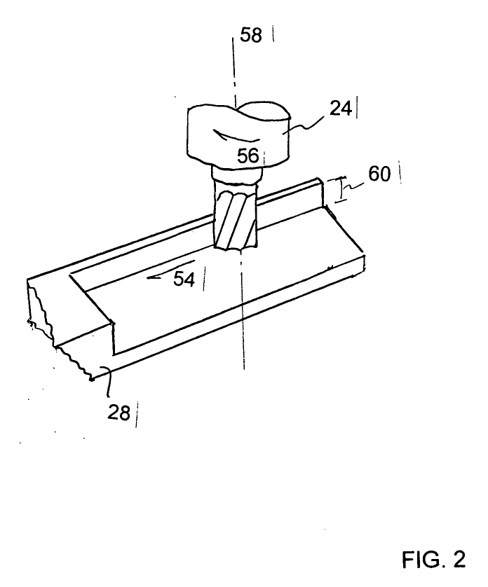

Referring to FIG. 2, a perspective view of an enlarged portion of a typical tool 24 interacting with a work piece 28 is shown. The tool 24, an end mill tool, moves laterally, as represented by arrow 54, generally towards the lower left hand corner in FIG. 2, at a feed speed (inches/minute). The tool 24 rotates, as represented by arrow 56, about a longitudinal axis 58 at a cutting speed. The tool 24 is adjusted relative to the work piece 28 such that it has an axial depth of cut 60.

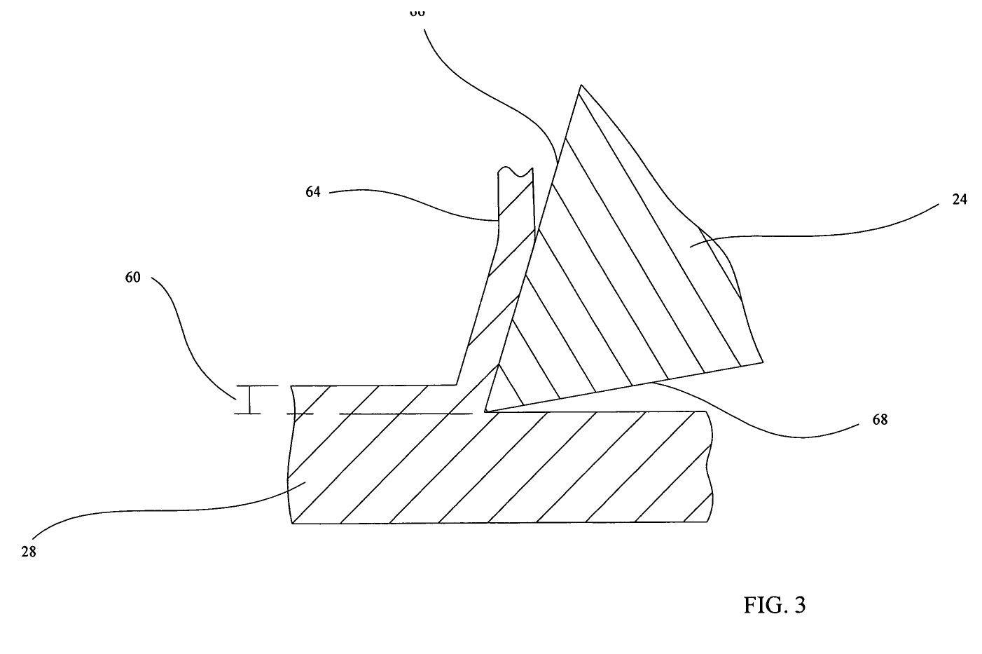

Referring to FIG. 3, a schematic illustration of the cutting process showing the work piece 28 and the tool 24 is shown. In certain machine operations, the cutting process removes material from the work piece 28 by producing chips 64. The tool 24 has a tool face 66 and a flank 68.

The interaction of the tool 24 with the work piece 28 creates tool wear. Tool wear is a gradual process generally and is dependent upon numerous factors including the tool and work piece material, the shape of the tool, cutting fluids used to assist in the cutting process, and process parameters such as the depth of the cut, the feed rate, and the cutting speed as discussed above with respect to FIG. 2. Two types of wear include flank wear and an edge or tool face wear.

Tool forces depend on the material being cut, the tool type, the geometry and status of the tool such as sharp or worn, and the cutting geometry (i.e., the path of the tool through the part). It has been recognized that the sensor data, such as required spindle power, acoustic emission, part or spindle vibrations, measured by indirect tool condition monitors, all ultimately depend on the tool forces. Since the tool forces are highly variable, the resulting sensor data can also be highly variable even as the tool remains in an acceptable state of wear.

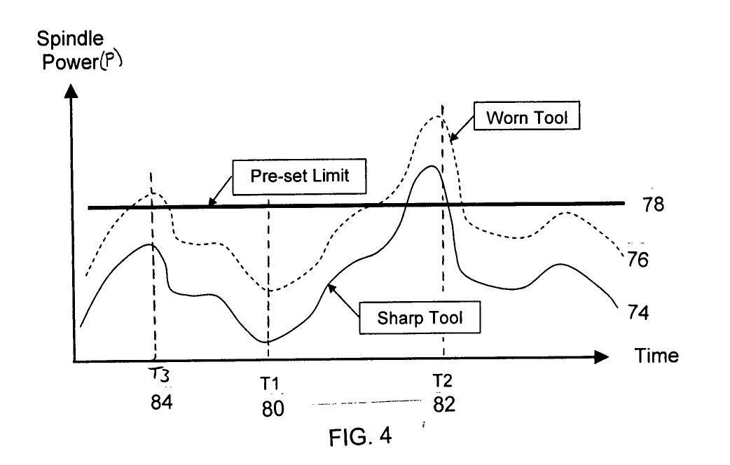

Referring to FIG. 4, a graph of an example of spindle power (P) versus time for various cutting conditions is seen. As shown in FIG. 4, spindle power P and the tool forces may vary over time due to both tool wear and due to normal process changes such as a variable depth of cut. For a tool 24, such as seen in FIGS. 1-3, that is sharp, the spindle power (P) varies with the depths of cut as the part is machined and is represented by the solid line 74. For a tool 24, that is worn, the spindle power (P) as represented by the dashed line 76 is generally higher than the recorded sharp tool power, for the same set of tool cuts, as the tool becomes dull. The simplest tool alarm strategy is to pre-set some limit on the overall spindle power as shown by the thick solid line 78 in FIG. 4.

Still referring to FIG. 4, the indicated pre-set limit 78 is above the spindle power (P) for a worn tool at T1 80, so no alarm is issued resulting in a false negative. At T2 82 , the sharp tool 24 as represented by line 74 and worn tool 24 as represented by line 76 each have spindle power (P) that is above the pre-set limit due, for example, to a particularly deep, but normal, depth of cut. A tool alarm would be issued at T2 82 even when the tool is still sharp resulting in a false positive. While at T3 84 the conditions are right such that there would be no alarm for the sharp tool 24 as represented by line 74, but an alarm for the worn tool 24 as represented by line 76 based solely on spindle power (P); a single, pre-set alarm level cannot handle normal tool cutting with variable depths of cut and associated variable spindle power (P).

Other conventional methods besides the pre-set limit 78 shown in FIG. 4, monitor the ratio of the actual (worn) to initial (sharp) tool spindle power over time. This method sets a variable tool alarm level over time for each tool motion at some off-set from the sharp tool spindle power profile. This removes much, but not all, of the dependence of the alarm on the cutting condition. The user is required to carry out initial experiments by cutting a sample part with a sharp tool and, often, a dull tool as well (to select an offset value on the spindle power versus time profile). Often multiple tools are used to cut the part. In that case, these experiments can become convoluted and expensive in time and material requiring several combinations of sharp and dull tools. This alarm strategy is referred to as a “learning” approach to tool wear monitoring.

This “learning” tool alarm strategy for a single tool works for a simple (constant depth of cut) part geometry and when the dominant wear mechanism is flank wear in that the spindle power and power ratio tracks quite well with the amount of wear.

However, there are a number of deficiencies in the conventional industrial practice of monitoring tool wear via spindle power. These include: [1] The spindle power profile is different for different parts, so the learning process must be repeated for each new part geometry. [2] The selection of a suitable offset for the spindle power alarm is problematic. There are no well established guidelines to determine when the tool wear is excessive. One solution is to cut with both a sharp and a dull tool to determine the spindle power process limits. But often several different tools are used to complete the machining of a particular part making the dual (sharp vs. dull tool) spindle power recording process overly cumbersome. [3] With particularly hard part materials, the tool wears very quickly and substantial wear can occur even over the first pass (“sharp tool” pass) for the part. Learning is not an option for this situation. [4] Small batch (custom) manufacturing is becoming commonplace, even down to batch sizes of one. The current industrial tool condition monitoring systems are only practical for large production batch sizes which may amortize the initial time and expense of the recorded tool cuts.

Pre-set sensor values can result in false positives or false negatives since the machining process is inherently variable, making a pre-set sensor value problematic. Tool condition monitors based on a learning process are useful, so long as the process is not changed—for example the same part is made with the same or equivalent set of tooling.

However the tool wear system 20 of the instant invention examines two process model parameters independently and does not require “learning” as in the conventional tool wear monitoring.

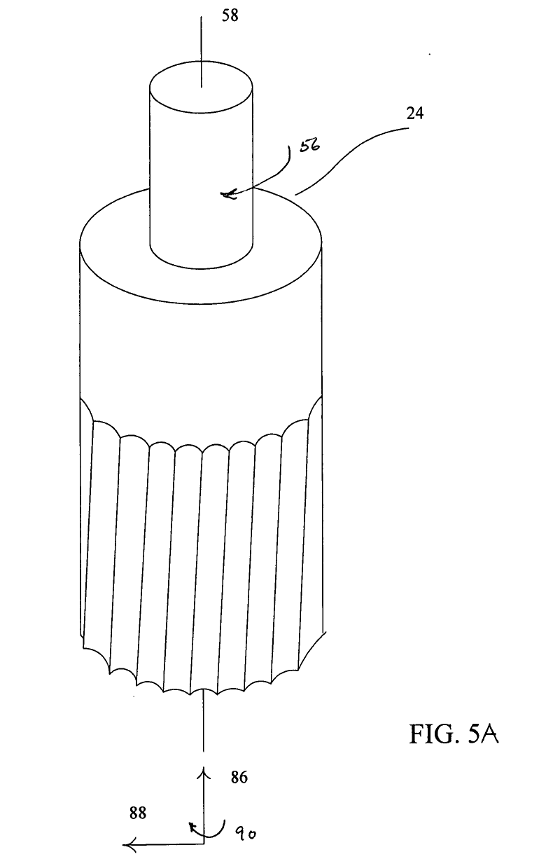

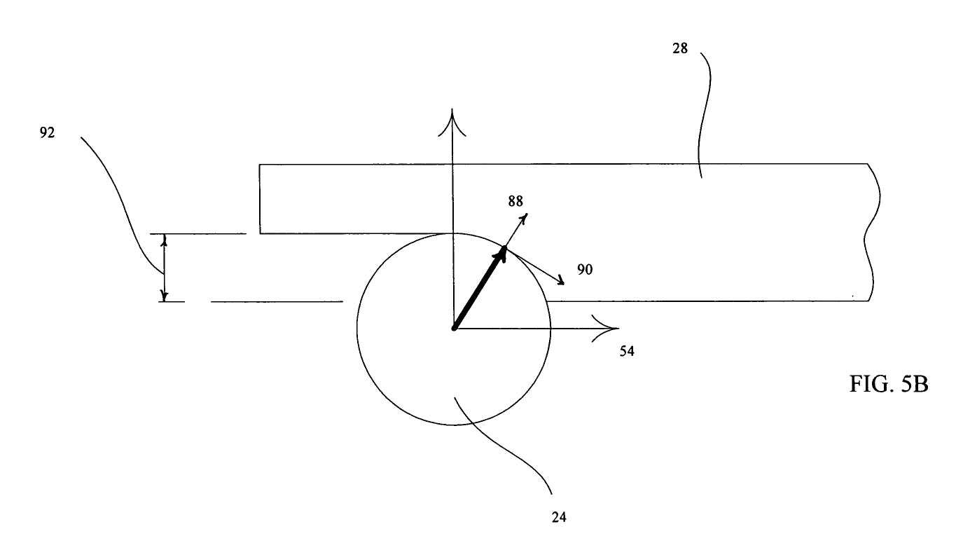

Referring to FIG. 5A, an isometric view of the tool 24 is shown. The tool 24 has the longitudinal axis 58 about which the tool 24 rotates as represented by the arrow 56. The tool 24 has forces acting on it in various directions. There is an axial component as represented by arrow 86 associated with forces parallel to the tool axis 58. There is a radial component as represented by arrow 88 associated with forces normal to the tool face direction. In addition there is a tangential component as represented by the arrow 90; this is the component parallel to the tool face direction.

Referring to FIG. 5B, a top view of a schematic illustration of a cutting process showing the work piece 28 and tool 24 is shown. The tool 24 moves laterally, as represented by arrow 54, generally towards the right side in FIG. 5B. The tool is adjusted relative to the work piece 28 such that it has a radial depth of cut 92. There is a radial component as represented by the arrow 88 associated with forces normal to the tool face direction. In addition there is a tangential component as represented by the arrow 90; this is the component parallel to the tool face direction.

Referring back to FIG. 3, in addition to the three directions of axial, radial, and tangential, the components can be edge process that are associated with the rubbing of the tool, the edge effect generally associated with the flank 68. These edge process model parameters are Kte, Kre, and Kae. The cutting term, Ktc, is related to the actual cutting process and associated more with the tool edge and face 66. The cutting geometry-independent terms are the process model parameters, Ktc and Kte. The process model parameters depend on the material being cut and, less so, the type and geometry of the tool.

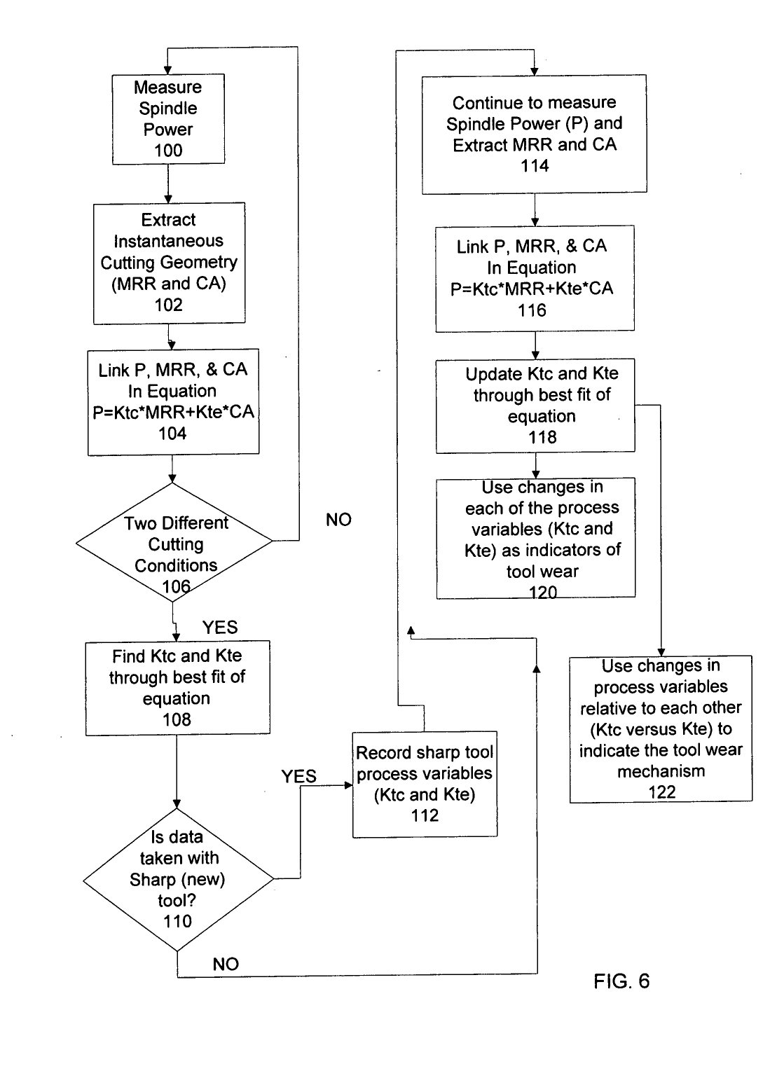

Referring to FIG. 6, a schematic of the method of the tool wear system 20 is shown. The system 20 measures spindle power (P) and extracts instantaneous cutting geometry of material removal rate (MRR) and contact area rate (CA) to determine process model parameters of edge contribution Kte and cutting Ktc. While the cutting geometry may vary widely and so also the spindle power, these changes are encapsulated in the cutting geometry-specific terms of MRR and CA. The cutting geometry-independent terms of Ktc and Kte will provide a less variable measure of the cutting conditions, specifically the condition of the tool.

The spindle power (P) is measured as represented by box 100. Spindle power is proportional to the product of the tangential component of the tool forces and the spindle speed. The power consumed when the tool is not cutting the material, the tare component of the spindle power, is excluded.

The instantaneous cutting geometry is extracted as represented by box 102. In particular, the material removal rate (MRR) and the contact area rate (CA) are extracted. The MRR is the volumetric removal rate of material from the work piece 28; the deeper or larger pass will increase the MRR. The CA is the average area in contact with the tool surface per tool revolution. For fixed spindle rotation speed, the MRR increases with the tool feed while the CA is independent of the tool feed.

The cutting geometry is extracted from a geometric model of the part that is continuously updated as the work piece 28 is being machined. Kte may be obtained from an extrapolation of the spindle power to zero material removal rate while Ktc may be obtained from the slope of the line relating spindle power to material removal rate. These two tangential process model parameters may be obtained in situ so long as the geometry of the tool cut has sufficient variation in the material removal rate.

In one embodiment, the software 50 associated with the computer 32 that drives the metal removal machine 22 as part of driving either the tool 24, the work table 30, or both knows the relationship of the tool 24 to the work piece 28 including the geometric cutting conditions. The geometric cutting conditions may be obtained from suitable modifications of commercially available virtual machining software known as NC verification.

The spindle power (P) time profile is matched with the geometric model and the MRR and CA as represented by block 104. The desire is to determine Ktc and Kte using the equation

P=Ktc*MRR+Kte*CA [1]

In that there is one equation and two terms to be determined, the spindle power (P) needs to match with the geometric model at more than one condition.

Decision diamond 106 represents determining if two different cutting conditions have occurred. If not, the no branch is followed back to block 100. If yes, the yes branch is followed to the next block, block 108.

Still referring to FIG. 6, block 108 represents determining Ktc and Kte from equation 1 with data at multiple cutting conditions.

If the data is taken with a new, sharp tool 24, the yes branch is followed from decision diamond 110 to block 112. Block 112 represents recording the sharp tool process variables of Ktc and Kte. The determination if the tool 24 is new or not is retained by the metal removal machine 22 and the computer 32. In one embodiment, the machine 22 automatically replaces tools 24 when necessary and the computer 32 resets the tool wear system 20 for that particular tool.

If the data is taken not from a new tool, but rather a worn or used tool, the no branch is followed from decision diamond 110.

Still referring to FIG. 6, both the no path from decision diamond 110 and the path from the block 112 go to block 114. Block 114 represents continuing to measure the spindle power (P) and extracting MRR and CA. With the continued measuring and extracting, P, MRR, and CA are linked in equation 1 as represented by block 116.

Ktc and Kte are updated using equation 1 as represented by block 118. The updated Ktc and Kte can be used for various purposes. For example, as represented by block 120, the changes in each of the process variables Ktc and Kte can be used as indicators of tool wear. In addition, as represented by block 122, the changes in process variables relative to each other, that is Ktc versus Kte, can assist in determining the mechanism of tool wear.

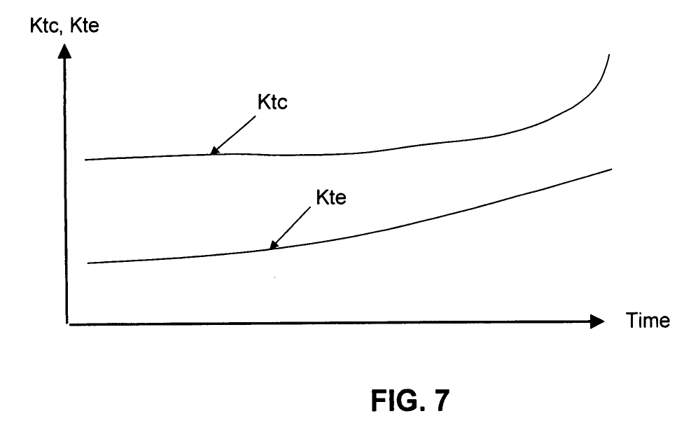

Referring to FIG. 7, a sample schematic graph of the variation in process variables (Ktc and Kte) over time is shown. In this example, Kte provides a slowly varying index of progressive wear while a rapid increase in Ktc near the end of the tool life provides an alarm when catastrophic failure is impending. Monitoring the values of these process variables obtained, for example, by measuring the spindle power over sufficiently variable material removal rate conditions, provides a reliable and part geometry independent measure of tool wear.

As indicated above, it has been recognized that the spindle power is attributed to two distinct contributions to the tangential cutting force. The standard contribution is from the cutting process per se and the other contribution is related to a rubbing or frictional component known as the edge effect. These two contributions can have very different dependencies on the state of tool wear. The standard contribution may be relatively independent of the state of tool wear while the edge effect contribution may be significantly effected. If the cutting conditions are such that the forces due to the standard contribution are significantly larger than that due to the edge effect, such as may occur in roughing cuts, then the wear may be masked if only power is monitored.

The process model of the tool wear system 20 provides some insight as to why the simple power ratio (current to initial power value) is not sufficient as a measure of tool wear. For some ratios of the feed to spindle rotation speed, the MRR term may dominate the tangential force and resulting spindle power while for smaller ratios (such as smaller feeds for the same spindle rotational speeds,) the contact area may be more prominent. If the main effect of tool wear is a change in the edge effect process model parameter (Kte), in the former case, the change in power over the sharp tool value due to tool wear will be less significant than for in the latter case, in which case the edge effect is more dominant. So, in this example and for a fixed state of tool wear, the power ratio may vary depending on the feeds and spindle rotation speed.

The edge effect tangential process parameter (Kte) may be expected to be more sensitive to changes in the flank or rubbing face while the cutting term tangential process parameter (Ktc) may be expected to depend, for example, on the sharpness of the tool tip. Consider the case where the dominant wear is flank wear, affecting mainly the edge effect process model (Kte). For some ratios of the feed to spindle rotation speed, the tool forces are mainly determined by the material removal rate contribution so any change in the edge effect term is less noticeable. Alternatively, for feeds and spindle speeds leading to smaller values of this ration, the contact area rate becomes more significant and changes in the edge effect similarly have a larger effect on the tool forces, spindle power, and the resulting power ratio.

In sum, previous tool monitoring systems have relied on following the progression of a process variable, such as spindle power, to determine tool wear. These methods are deficient since the change in the process variable may arise from tool wear or from a normal variation in the cutting condition. Simply measuring the process variable without information on the cutting condition is insufficient in determining tool wear. Table 1 provides a summary of some key differences between the Invention method and conventional industrial tool wear monitoring systems.

TABLE 1
COMPARISON OF SPINDLE POWER AND PROCESS MODEL METHODS
FOR TOOL WEAR MONITORING

| | Spindle Power | Process Model |
|---|---|---|
| | Method | Method |
| Different Part | Need to re-learn sharp (and | No new learning needed. Use past |
| Geometry | dull) tool spindle power profile | experience with similar tool and |
| | for each new part geometry. | part material, but different part |
| | | geometries, to determine worn tool |
| | | process model parameters. |
| Scrap Parts/Testing | Need to cut test (and then | No need for test parts. Information |
| | scrap) parts for each new part | can be captured from the first few |
| | geometry. Only suitable for | tool cuts in a normal cutting |
| | large production volumes. | operation. Handles all production |
| | | volumes, even batch sizes of one. |
| Hard Materials | Significant tool wear over the | Capture of the process model |
| | first test part means there is no | parameters early in the machining |
| | “sharp tool” threshold value | operation accommodates rapid tool |
| | over the entire cutting | wear monitoring. |
| | operation. | |
| Complexity & | User must carry out detailed | Capture of process model |
| Expense | experiments to complete the | parameters is transparent to the end |
| | learning process. May be | user. No special expertise is |
| | repeated for every possible | required. |
| | sharp and dull tool combination | |
| | for parts cut with multiple | |
| | tools. | |
| Diagnosis | Purely empirical. Offers little | Based on a physical model of the |
| | information regarding the | cutting process. Provides insight |
| | dominant tool wear mechanism. | into the dominant tool wear |
| | | mechanism. |

While the principles of the present invention have been described herein, it is to be understood by those skilled in the art that this description is made only by way of example and not as a limitation as to the scope of the invention. Other embodiments are contemplated within the scope of the present invention in addition to the preferred embodiments shown and described herein. Modifications and substitutions by one of ordinary skill in the art are considered to be within the scope of the present invention, which is not to be limited except by the following claims.

It is recognized that the relation between power and the tangential process model parameters in Eqn. [1] provides a particular and important example of the use of the tangential process model parameters (Ktc and Kte) as measures of tool condition monitoring that are independent of the cutting geometry. However, the remaining process model parameters (Krc, Kre, Kac, Kae) may also be used in a similar fashion.

The invention claimed is:

1. A method of measuring tool wear comprising:
monitoring the spindle power of a machine;
determining at least two pieces of cutting geometry data related to a work piece;
performing at least two different cutting operations on the work piece;
calculating at least two process model parameters; and
continuing to monitor the spindle power and the determination of at least two pieces of cutting geometry data and variation of the process model parameters over tool use in the machining operation whereby the change in the process model parameters over tool use is a measure of tool wear.

2. A method of measuring tool wear of claim 1 wherein the at least two pieces of cutting geometry data include the material removal rate (MRR) and the contact area rate (CA).

3. A method of measuring tool wear of claim 2 wherein the material removal rate and the contact area rate are determined by cutting geometry data.

4. A method of measuring tool wear of claim 1 wherein the at least two process model parameters include the tangent cutting coefficient (Ktc) and the tangent edge coefficient (Kte).

5. A method of measuring tool wear of claim 4 wherein the at least two process model parameters are determined using the equation P=Ktc*MRR+Kte*CA.

6. A system for monitoring tool wear comprising:
a machine having a spindle for receiving a tool for cutting a work piece;
a mechanism for controlling the motion of the tool relative to the work piece;
a mechanism for determining the power of the spindle;
a mechanism for determining at least two pieces of cutting geometry data related to the cutting of the work piece;
a mechanism for calculating at least two process model parameters based on the spindle power and the cutting geometry data; and
a mechanism for outputting the process model parameters.

7. A system for monitoring tool wear of claim 6 wherein the mechanism for outputting the process model parameter is a graphic display.

8. A system for monitoring tool wear of claim 6 wherein the at least two pieces of cutting geometry data include the material removal rate (MRR) and the contact area rate (CA) and the at least two process model parameters include the tangent cutting coefficient (Ktc) and the tangent edge coefficient (Kte).

9. A system for monitoring tool wear of claim 8 wherein the at least two process model parameters are determined using the equation P=Ktc*MRR+Kte*CA.

10. A method for monitoring tool wear in CNC machining operations:
(a) using a physics-based two parameter process model
(b) using spindle power and cutting geometry data to determine the process model parameters
(c) monitoring the variation of the process model parameters over tool use in the machining operation
whereby the change in the process model parameters over tool use is a measure of tool wear.

11. A method of claim 10 wherein the changes in the two process model parameters relative to each other is a diagnostic of the dominant tool wear mechanism.

12. A method of claim 10 wherein the spindle power may be measured directly or may be obtained from a suitable open architecture CNC control.

13. A method of claim 10 wherein the geometry of the cutting process may be determined with a suitable geometric modeling system working in concert with the spindle power measurements.
